(19) United States
(12) Patent Application Publication
(10) Pub. No.: US 2013/0038063 A1
(43) Pub. Date: Feb. 14, 2013

(54) APPARATUS AND METHOD FOR INHIBITING THE FORMATION OF TROPICAL CYCLONES

(71) Applicant: Jack Joseph Tawil, Merritt Island, FL (US)

(72) Inventor: Jack Joseph Tawil, Merritt Island, FL (US)

(21) Appl. No.: 13/584,205

(22) Filed: Aug. 13, 2012

Related U.S. Application Data
(60) Provisional application No. 61/523,024, filed on Aug. 12, 2011.

(51) Int. Cl. A01G 15/00; F03B 13/16; F04B 9/10

(52) U.S. Cl. 290/53; 417/331; 137/560; 239/2.1

(57) ABSTRACT

An apparatus for inhibiting the formation of tropical cyclones, comprising an elongated rigid tube through which cooler water is pumped from below to the near-ocean surface, thereby depriving incipient tropical cyclones of the heat energy they require for further development. The tube contains a pump comprising a fixed flap valve and a movable flap valve. The movable flap valve is attached to a drive disk encircling the tube at a depth where ambient waters have little vertical motion. The wave-driven vertical motion of the elongated tube causes the movable flap valve to oscillate with respect to the fixed flap valve, thereby pumping seawater upward onto the near-ocean surface. The apparatus also can navigate to alternative locations by means of a propulsion/steering system, and it can submerge to a safe depth to avoid oncoming vessels and potentially damaging seas. A fleet of apparatuses is required to provide the necessary cooling effect.

### CROSS-REFERENCE TO RELATED APPLICATIONS

This application claims the benefit of provisional patent application No. 61/523,024, filed Aug. 12, 2011.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to tropical cyclones, and, more specifically, to inhibiting the formation of tropical cyclones.

2. Prior Art

An early attempt to mitigate the destructive forces of hurricanes took place between 1962 and 1983 with a series of experiments known as project STORMFURY, carried out jointly by the U.S. Navy and the U.S. Weather Bureau, as it was then called. During these experiments, crystals of silver iodide were dropped into hurricane rainbands. It was theorized that the crystals would freeze the supercooled water in the rainbands, causing them to grow and weaken the eye wall. STORMFURY failed because hurricanes contained insufficient supercooled water, and the natural variability of hurricanes made it too difficult to interpret the experimental results.

Other approaches involving cloud seeding are disclosed in U.S. Pat. Nos. 6,315,213 to Cordani (2001), 5,357,865 to Mather (1994), 5,174,498 to Popovitz-Biro, et al. (1992), 5,441,200 to Rovella, II (1995), 4,600,147 to Fukuta, et al. (1986) and 4,096,005 to Slusher (1978). For example, Cordani's patent utilizes a super-absorbent polymer to cause a large absorption of water, resulting in a gel-like substance that precipitates to the surface and lessens storm velocities. The patent to Rovella discloses combining the water vapor in the storm with sodium tartrate powder or, alternatively, cupric sulphate to form heavier drops that disrupt the eye wall through centrifugal force. These chemical approaches all have the potential to cause serious environmental harm, and since the cyclone has already formed and contains a tremendous amount of energy, the volume of chemicals required would undoubtedly be substantial.

U.S. Pat. No. 7,798,419 to Solc (2010) discloses a wind-driven on-site pump that pumps into the eye wall a large volume (100's of m³sec⁻¹) of seawater, which is carried aloft up to 10 to 15 km. The centrifugal force of the ascending water is said to impede the circular flow of the cyclone, inhibiting its further development. A disadvantage of this approach is the difficulty of injecting a sufficient volume of seawater into the eye wall to significantly affect the tremendous energy already contained in the cyclone. Moreover, constructing a water-injecting device of adequate capacity that could also withstand the huge sea and wind forces in and around an existing tropical cyclone would be challenging.

U.S. Pat. No. 7,520,237 to Zhekov (2009) utilizes a wind-driven on-site pump, mounted on a securely moored and buoyant platform, to pump a large volume of on-site seawater into the eye wall, which is carried aloft, thereby reducing the wind circulation velocity near the eye wall. A water pipe for sucking up the water is to extend to a depth of 450 to 500 feet, where water temperature is around 11 degrees C. This device has several apparent disadvantages, compared with the current invention. There is the cost for the platform, the mooring system, the wind turbine and its structure, the vertical pipe that extends downward 450 to 500 feet into the ocean and the associated electrical and mechanical systems. Moreover, the components and structures need to be fabricated to withstand the tremendous forces associated with hurricanes and high seas. Zhekov also describes how his structure can create bubbles to lower sea surface temperatures. Two principles operate here: the rising of the air bubbles physically push the ambient seawater upward; and through heat transfer, the cooled air within the bubbles absorbs heat from the water in the upper regions as the bubbles ascend, thereby cooling it. A major disadvantage with this method is that the compressors producing the bubbles would have to overcome deep sea pressures to function effectively. There is also a problem of scale: a large number of units would be necessary to achieve sufficient cooling, and there could be a problem of supplying the compressors with sufficient power.

U.S. Pat. No. 8,161,757 to Rosen (2012) describes using a navigable vessel with a plurality of artificial snow-making devices to spread artificial snow in the path of an existing tropical cyclone. A major disadvantage with this technique is the huge amount of snow that would be required to significantly reduce the intensity of an existing cyclone.

U.S. Patent Application 2002/0008155 to Uram (2002) discloses a method and system for first detecting the onset of a hurricane region and then rushing one or more apparatuses to the area to cool the surface waters, thereby inhibiting or weakening the hurricane's formation. A retired submarine is the preferred embodiment for pumping cooler waters from below the surface onto the surface waters. In a later U.S. Patent Application 20050133612 to Uram, a method is disclosed for rushing one or more submarine pumping systems directly below a tropical storm in its infancy and to pump cooler water onto or near the surface waters beneath it to deprive the storm of the energy it requires for further strengthening. This invention requires prior detection of a tropical cyclone, the rapid deployment of the pumping units and a pumping capability sufficient to cool the waters in the storm's path.

U.S. Pat. No. 7,832,657 to Kitamura (2010) discloses a device comprising a plurality of elongated, substantially rigid pipes, each with a suction port and an injection port, a pump to suck cold water from the suction port out onto an aim region below the sea surface; an elongated, horizontally oriented platform, that is submerged, with the plurality of pipes secured to the underwater platform. The pipes are pivotable to minimize water resistance when the platform is being relocated. A retired submarine is the preferred embodiment for the pumping function.

Another technique for cooling surface waters with cool subsurface waters is described in U.S. Pat. No. 8,148,840 to Gradle (2012). His apparatus is operated from within the eye of a hurricane and travels along the anticipated track of the storm, staying within the eye. The apparatus comprises a wind turbine mounted on a platform that pumps water with a temperature at least 20 degrees C. cooler than the surface water temperature into a plurality of pipes. These pipes then inject the water into an elongate tube through which is passing an air stream, and the atomized air-water mixture is injected into the hurricane eye to de-energize the storm. One significant disadvantage with this method is that such cold water would normally be found only at considerable depth, and moving a platform along the surface at a speed sufficient to stay within the hurricane eye and with pipes extending downward to the required depth could impose a tremendous force at the juncture of the pipes and the platform. To deal with this, Gradle mounts one or more impellers on the shaft to reduce the strain, but keeping the impellers synchronized while driven by a variable power source, such as a wind turbine, could be challenging.

In Super Freakonomics (S D Levitt and Dubner S J, William Morrow & Co., 2009), the authors report on inventors who are proposing a method for cooling surface seawaters in which a multiplicity of rings is floated on the ocean surface, each with a flexible tube extending downward into the cooler regions of the ocean. The rings extend above the surface so that when they are overtopped by waves, seawater within the rings is momentarily above sea level. The resulting hydraulic pressure will push the warmer surface water downward through the bottom of the flexible tubes, forcing cooler water upward as the water is ejected. The inventors claim that the devices can be very inexpensive, but they acknowledge that towing a large number of them to the preferred locations and mooring them would be costly. Barber, in U.S. Pat. No. 7,536,967 (2009) discloses a similar method, except that surface waters are forcibly injected into a region with cooler waters, forcing the cooler waters to rise to the surface.

3. Objects and Advantages

In most years, hurricanes cause major property damage in the United States. Katrina alone caused estimated damages of $85 billion in 2005. Blake et al. report estimates for the thirty costliest hurricanes to hit the United States since 1900.¹ Measured in contemporaneous dollars, damages total damages were estimated at $312 billion, or $408 billion in 2010 dollars. If each of those same hurricanes had struck the U.S. in the same way but with our current population distribution and current property exposure, the estimated total damages would have soared to slightly over $1 trillion. In the 112 years since 1900, the average annual loss from just these 30 hurricanes exceeds $9 billion per year. This estimate for hurricane Katrina, as well as the other statistics in this paragraph are from “The Deadliest, Costliest, and most Intense United States Tropical Cyclones from 1851 to 2006 (and other Frequently Requested Hurricane Facts),” Eric S. Blake, Rappaport, Edward N., and Landsea, National Hurricane Center, Miami, FL, updated 15 Apr. 2007.

Hurricanes also cause substantial loss of life. While over 8,000 deaths were attributed to the 1900 Galveston hurricane, Katrina caused at least 1,500 deaths in 2005, even with the substantial progress over the past several decades in advanced warnings, emergency management plans, improved evacuation capabilities and more wind-resistant structures.

It has been suggested that all Atlantic tropical cyclones, and even some tropical cyclones forming in the Pacific, originated as tropical waves from Africa's West Equatorial coast, where they derive their power from warm sea-surface temperatures (SSTs) [http://www.physorg.com/news6753.html]. That is why the hurricane season begins in summer, after hot winds have warmed the coastal surface waters to above 80° F. Since water temperatures in the thermoclines below the sea surface are significantly cooler, a logical strategy for inhibiting tropical cyclone formation, as suggested by the prior art, is to bring cooler waters to the surface, thereby depriving the tropical waves of the heat energy they require to evolve into large, powerful and destructive storms. This potential to materially inhibit the formation of tropical cyclones by disrupting their formation off the West Coast of Africa is substantial.

The basic invention is an apparatus that is suspended from the ocean surface and that pumps cooler water from below the ocean surface out onto the near-ocean surface. The pump is driven by wave energy and comprises two one-way valves, one fixed and one movable. By preventing SSTs from reaching the critical temperature of 80° F., the development of tropical cyclones can be inhibited.

Another embodiment of this invention enables the apparatus to navigate to a pre-determined location. Yet another embodiment enables it to submerge to some pre-determined depth during heavy seas, during periods of calm, or when the apparatus is in the path of an approaching ship, and to re-emerge after these conditions no longer obtain. Still another embodiment enables the apparatus to operate as one member of a fleet of similar apparatuses, each maintaining its distance from the others in order to achieve a relatively uniform distribution of the cooler waters.

The objects and advantages of the apparatus, as a result of inhibiting the formation of tropical cyclones, include major reductions in:

(a) loss of life from wind, storm surge, flooding and evacuation accidents;

(b) economic losses from wind and water damage;

(c) costs and inconvenience attributable to evacuations;

(d) loss of electrical power;

(e) disruption to national, regional and local product supply chains, including disruption of energy supplies;

(f) loss of use of property;

(g) disruption of the daily lives of residents in at-risk areas;

(h) resources necessary to respond to and recover from tropical cyclones;

(i) cost of hurricane insurance premiums, including flood insurance; and

(j) anxiety among at-risk populations from an approaching storm.

### SUMMARY

The present invention is a method and an apparatus for inhibiting the formation of tropical cyclones, comprising an elongated rigid tube open at both ends, a flotation device at the top end, a weighting device at the bottom end; and a wave-driven device for pumping cooler seawater from the bottom end, through the tube and out onto the near-ocean surface. Additional major embodiments include a means for propelling and steering the apparatus and a means for submerging the apparatus and causing it to re-emerge.

In the drawings, closely related elements may be designated by the same number but with a different alphabetic suffixes.

### DRAWINGS

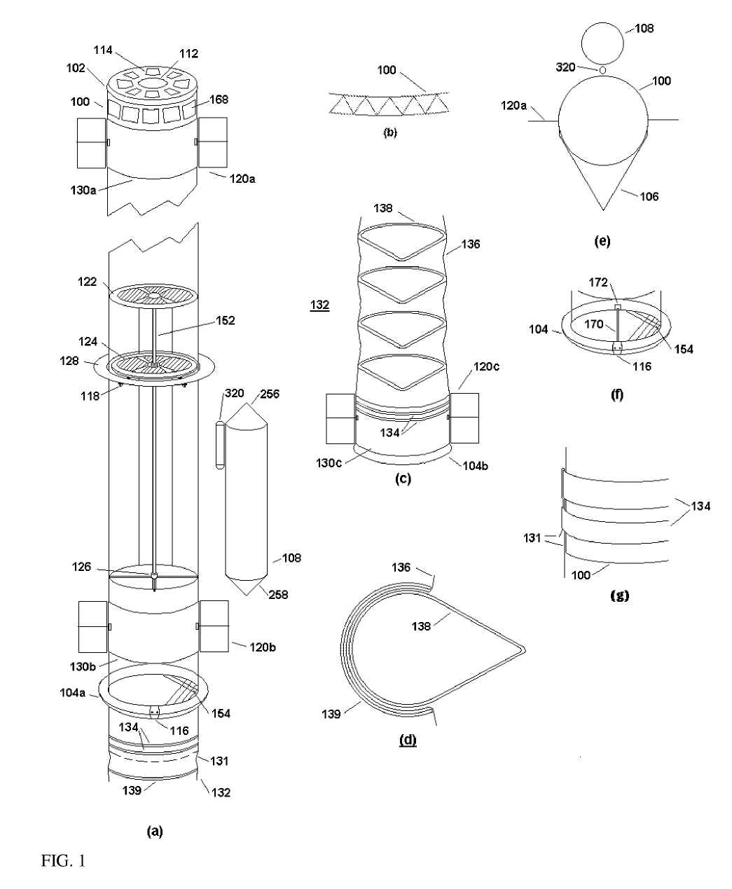

### FIGS. 1-6

FIG. 1. An apparatus for inhibiting the formation of tropical cyclones

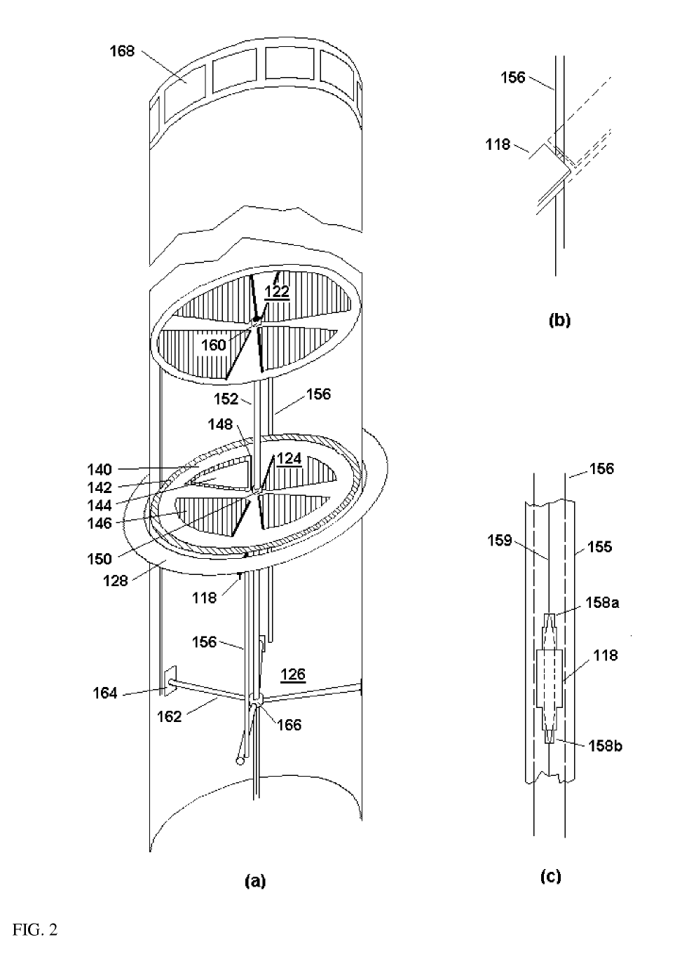

FIG. 2. A pumping device for forcing cooler seawater upward

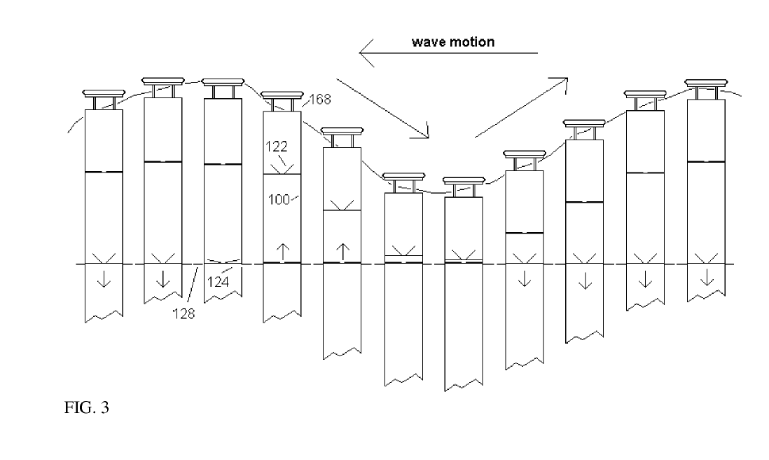

FIG. 3. The valve action of the pump system in conjunction with wave motion

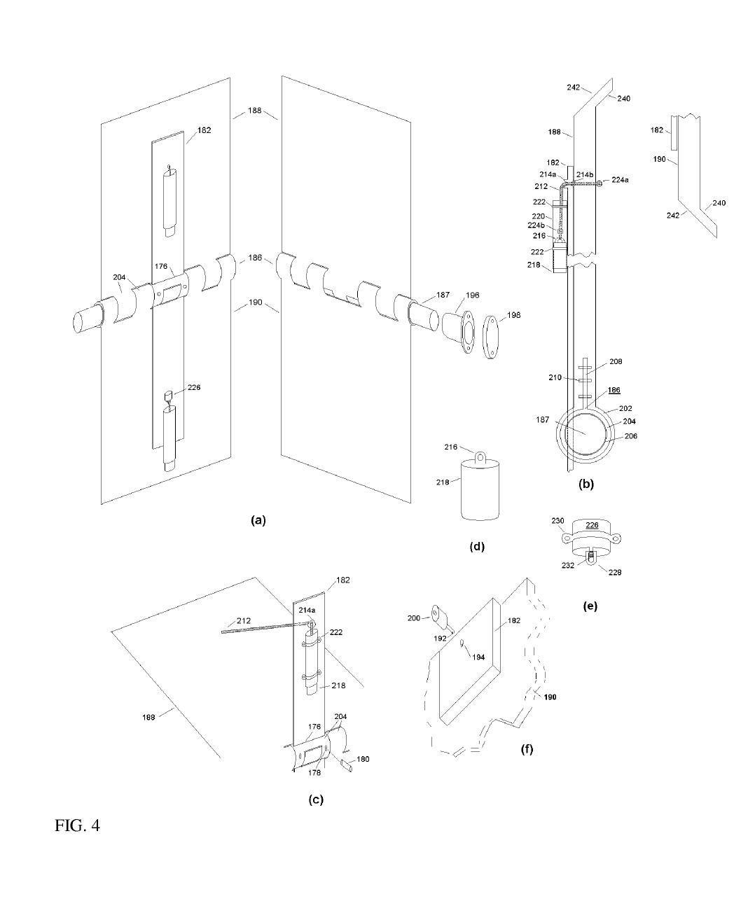

FIG. 4. The elements of the navigational system

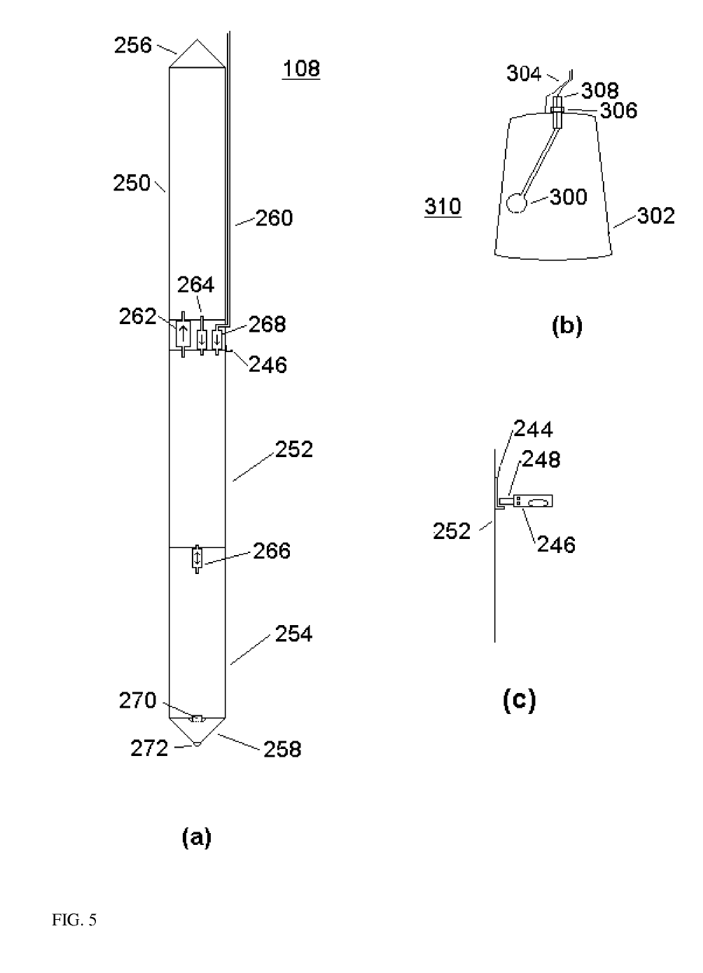

FIG. 5. The elements of the depth-control system

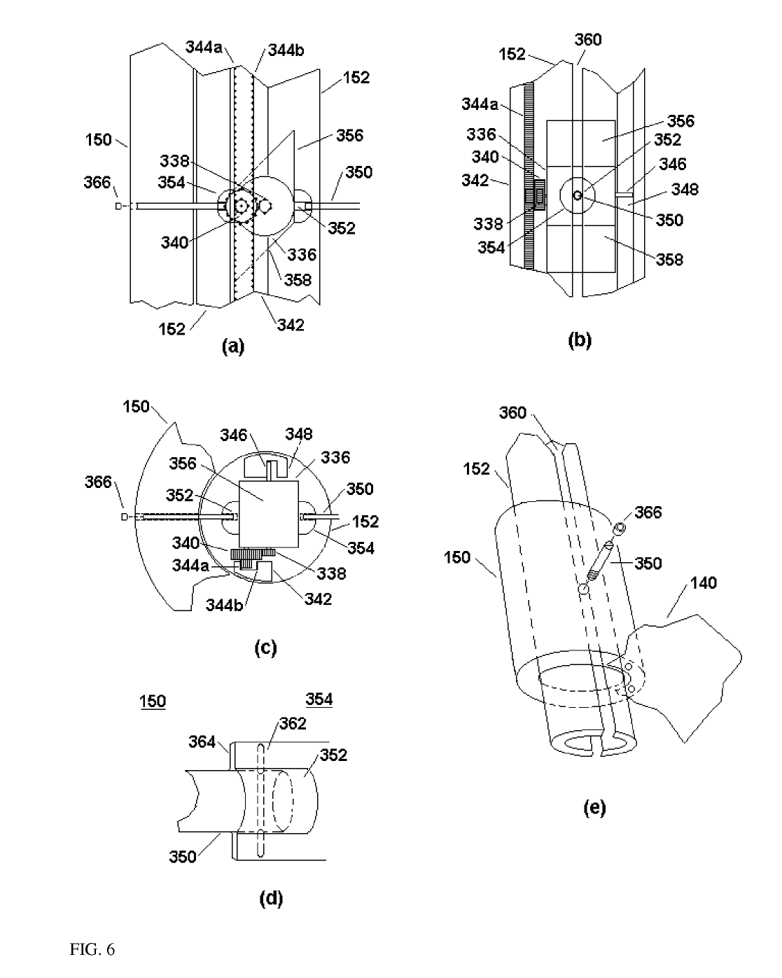

FIG. 6. A device for producing onboard electricity

DRAWINGS-Reference Numerals

100—rigid elongated tube
102—flotation device
104a—tube weighting device
104b—tube extender weighting device
106—fairing
108—water-ballast system
112—electronics package
114—solar cell
116—storage battery
118—rigid connecting member
120a—upper steering vane assembly
120b—lower steering vane assembly
120c—tube extender steering vane assembly
122—one-way fixed flap valve
124—one-way movable flap valve
126—support framework
128—drive disk
130a—upper pipe coupler
130b—lower pipe coupler
130c—tube extender pipe coupler
131—elasticized fabric
132—tube extender
134—tube extender clamp
136—flexible tubing
138—tube supporting rib
139—rib clamp
140—flap valve disk
142—elastomeric annulus
144—rigid plate
146—flat flap
148—flap valve hinge
150—bushing
152—pump shaft
154—strainer
155—elastomeric strip
156—vertical slots
158a—upper two-way slider
158b—lower two-way slider
159—elastomeric strip slit
160—cap
162—spoke
164—bracket
166—hub
168—water discharge opening
170—skeg
172—bracket
176—hinge slot
178—pinholes
180—pin
182—vertical stop
186—steering vane hinge
187—steering vane hinge shaft
188—upper steering vane panel
190—lower steering vane panel
192—pin
194—keyhole
196—mounting flange
198—mounting flange backer plate
200—rotary actuator
202—fiberglass covering
204—hinge knuckle
206—PTFE hinge lining
208—hinge leaf
210—reinforcing pin
212—marine rope
214a—outer fairlead
214b—inner fairlead
216—weighted container ring
218—weighted container
220—weight travel-guide tube
222—PVC clamp
224a—first nylon stop
224b—second nylon stop
226—rope-clamp pull-type solenoid
228—D-ring
230—solenoid mounting strap
232—ribbed clamping strip
240—flare
242—bevel
244—bracket
246—mercury switch
248—elastomeric hinge
250—upper air tank
252—vacuum tank
254—ballast tank
256—upper fairing
258—lower fairing
260—air tube
262—air pump
264—first one-way solenoid air valve
266—two-way solenoid air valve
268—second one-way solenoid air valve
270—thru-hull fitting
272—strainer
300—bell clapper
302—bell casting
304—bell electrical circuit
306—adjusting nut
308—electrical insulator (bell)
310—motion detector
320—emergency ascent capsule
336—generator/dynamo
338—drive gear
340—reduction gear set
342—gear-strip mount
344a—first gear strip
344b—second gear strip
346—guide rod
348—guide-rod channel
350—slide shaft
352—slide-shaft bore
354—slide-shaft block
356—upper bevel block
358—lower bevel block
360—vertical slots in pump shaft
362—domed pin
366—slide-shaft hole cap

### DETAILED DESCRIPTION

### Preferred Embodiment—FIGS. 1, 2, 4 and 5

A preferred embodiment of the current invention is shown in FIG. 1a. The components of this apparatus are ruggedly constructed from materials highly resistant to seawater corrosion. Components near the ocean surface are constructed from materials that are also resistant to ultraviolet radiation. All components should be able to survive repetitive and constant pressures of at least three to five atmospheres. Commercially available components and materials will allow the apparatus to operate substantially trouble-free for a period of at least five years without maintenance. Most surfaces that are exposed to seawater are sprayed or otherwise coated with an ablative-type, anti-fouling coating, which can give protection against marine growth for up to eight years.

A large plurality of apparatuses operates together as a fleet of apparatuses, with a master apparatus exercising remote control over other apparatuses in its fleet. One or more fleets operate in region(s) of the ocean whose surface waters are to be cooled.

As shown in FIG. 1a, the body of the preferred embodiment of the apparatus is a non-corrosive, rigid, substantially cylindrical elongated tube (100) 120 inches in diameter with a flotation device (102) at or near its upper extremity and a weighting device (104a) at or near its lower extremity. The rigid tube is fabricated from polyvinyl chloride (PVC), polyethylene or other material, depending upon current costs, as well as other considerations. For example, the wall thickness of the tube depends upon expected environmental conditions, as well as on the material, its durability and construction. FIG. 1b depicts a double-walled tube with interior structural members that give the tube a higher strength-to-weight ratio. The length of the rigid tube will depend in major part on typical wave heights in the environment in which it will operate.

To add directional stability to the apparatus, a wedge-shaped, rigid plastic fairing (106) is attached with PVC fittings to the front of the rigid tube, as shown in FIG. 1e. The fairing extends from the bottom of the upper steering vane panel set (120a) to the top of the lower steering vane panel set (120b). With the fairing attached, the top-view cross-section of the apparatus presents a tear-shaped profile. The orientation of the fairing with respect to the upper steering vane panel set (120a) is also shown in FIG. 1e.

The length of the rigid tube is extended by means of a relatively inexpensive, flexible tube extender (132). The overall length of the tube extender is sufficient to reach seawater with a temperature in summer months at least several degrees Fahrenheit cooler than the sea surface temperature (SST) during warmer months. These cooler temperatures are typically found within the lower region of a thermocline. The specific overall length of the tube is to be determined by the marine environments in which the apparatus is expected to operate.

The construction of the tube extender is shown in FIGS. 1c and 1d. The extender is comprised of a length of flexible tubing (136) fabricated from heavy plastic film, supporting ribs (138) spaced several feet apart and rib clamps (139). The radius of curvature of the circular portion of the ribs is substantially the same as that of the circular tube, and the wedge-shaped portion of the ribs conforms to the shape and dimensions of the fairing (106).

As shown in the cross-sectional view in FIG. 1d, the flexible tubing (136) is positioned between the ribs (138) and the rib clamps (139). The clamps hold the ribs and tubing in place by clamping the tubing onto the ribs. The bottom of the tube extender folds onto itself to form a pocket around the circumference of the tubing. The pocket (104b in FIG. 1c) is filled with a heavy but inexpensive substance. Sand, which has a specific gravity of approximately 2.65 and is generally abundant around coastal marine environments, is the preferred substance; the pocket is clamped shut with a rib and rib clamp. One skilled in the art can determine the mass of the weighting device that is sufficient to overcome hydraulic drag as the apparatus rides the waves. Both the ribs and the rib clamps are constructed from PVC or similar material. The tube extender can be folded accordion-like into a relatively compact, stackable package for economical transport to the site where the apparatuses are launched after final assembly.

Between the rigid tube and the tube extender is a tubular length of expandable or elasticized fabric (131) to absorb shock should the apparatus experience a shock or suddenly change its vertical speed and/or direction. At its upper end, the elasticized fabric is held in place with tube extender clamps (134) constructed from two straps of webbing, as shown in FIG. 1g. The fabric is clamped between the upper webbing clamp and the rigid tube. The fabric is then folded over the outside of the upper webbing clamp and clamped onto itself and the rigid tube by a lower (132 in FIG. 1c) with a rib-and-clamp arrangement similar to that shown for the supporting ribs (138) and clamps (139) in FIG. 1d.

Upper and lower steering vane panel sets (120a and 120b) are mounted in plastic pipe couplers (130a and 130b) that can connect sections of the rigid tube (100). Steering vane panel sets also can be installed on the tube extender as needed; the couplers are attached to the tube extender by means of tube extender clamps (134), as shown in FIG. 1c.

In the preferred embodiment, the tube weighting device (104a) is a rugged, rigid, circular tube surrounding and attached to the lower outside perimeter of the rigid tube and filled with sand for ballast. One or more storage batteries (116) may be incorporated within the weighting device.

In the preferred embodiment, the flotation device (102) is a rugged, rigid, round tube that surrounds and is attached to the upper outside perimeter of the rigid tube (100). The buoyancy of the entire apparatus, inclusive of other embodiments, is controlled by a water-ballast or submersion system (108) that is described later. There is also an electronics package (112) comprising, in the preferred embodiment, a global positioning system (GPS), a controller for providing the means to control current from at least one solar cell (114) to at least one long-life, deep-cycle storage battery (116), an antenna and receiver for receiving electronic signals, a transmitter for communicating information to other apparatuses in the fleet, a turbulence detector, temperature sensors, a mercury switch, a tilt meter; and, for controlling the submersion (108) and steering vane panel sets (120a, 120b and 120c), an electronic depth gauge, a processor, solenoids and an air pump. A transmitter on the master apparatus is capable of transmitting information to onshore receivers. In the preferred embodiment, there is also a package containing a plurality of solar cells (114) mounted on the top of the rigid tube.

PUMPING. In the preferred embodiment shown in FIG. 1a, the means for pumping cooler seawater upward through the rigid tube to the near-ocean surface is a pumping system comprising a one-way fixed flap valve (122) attached to the rigid tube (100) and a one-way movable flap valve (124) with supporting framework (126). The framework comprises a hub (166 in FIG. 2a) and a plurality of spokes (162 in FIG. 2a) fabricated from PVC. The movable valve is attached by means of a plurality of strong, rigid connecting members (118) to a flat outer drive disk (128) or ring that surrounds the rigid tube. The movable valve and drive disk are at a depth at which the ocean is normally vertically stable. The movable valve slides within the tube along a vertical PVC pump shaft (152), and the connecting members move within vertical slots (156 in FIG. 2a) that are fabricated into the rigid tube. The pumping system is powered by wave motion: the flat outer drive disk and the movable valve to which it is attached maintain their vertical position relative to ambient water that is generally vertically stable, while the fixed valve undulates with the waves, thereby causing seawater to be pumped upward through the rigid tube, through the valves and onto the near-ocean surface through water-discharge openings (168) near the top of the tube. The bottom opening of the tube is covered with a strainer (154 in FIG. 1f) that prevents foreign objects from entering the tube and interfering with the operation of the flap valves.

FIG. 2a shows the pumping device, or pump assembly, in greater detail. In the preferred embodiment, the movable flap valve (124) consists of a flap valve disk (140) with a diameter slightly less than the inner diameter of the rigid tube within which it operates. The disk contains four apertures (not shown), one in each quadrant of the disk. Overlapping each aperture on all sides is a flat flap (146) that is fabricated from an elastomeric material and that cover the apertures. Each flap is attached to the disk with a stainless steel hinge (148) along one straight side. On the top of each flap, there is attached a rigid plate (144) that substantially conforms to the outer edges of the aperture. In the preferred embodiment, it is slightly smaller than the aperture and centered within its non-hinged sides. The purpose of this plate is to facilitate a seal between the disk surface and the flap. An elastomeric annulus (142), whose outer circumference edge is shaped like a squeegee blade, is fabricated from a durable material that is affixed to the outer rim of the disk. It has a diameter slightly greater than the inside diameter of the rigid tube, thereby providing a seal between the inner surface of the rigid tube and the outer circumference of the disk. When the disk changes direction as it slides within the tube, friction causes the outer edge of the annulus to flip direction and to point in the opposite direction in which the disk is moving, similar to the action of a windshield wiper blade upon a windshield.

In the center of the movable valve is a bushing (150) through which the shaft (152) of the pump assembly oscillates. The inner wall of the bushing is fabricated from a non-corrosive, low-friction and durable material, such as PTFE in the preferred embodiment. The drive disk (128) of the assembly is connected to the movable valve by means of rigid, “T”-shaped connecting members (118) that are attached to the disk between its apertures, and are connected to the outer drive disk through vertical slots (156) in the rigid tube. These connecting members are preferably made from stainless steel, and the valve disk (140) and drive disk are preferably fabricated from fiberglass.

It is desirable that the vertical slots be as narrow as possible to minimize water leakage through them during pumping. FIG. 2b shows a view of the rigid tube where a connecting member (118) extends through a vertical slot (156). The connecting member has an “I” cross-section rather than a “T” cross-section within the slot itself, so that the slot can be narrower. To further reduce leakage, FIG. 2c shows a low-friction, abrasion-resistant, flat elastomeric strip (155), which completely covers each slot. The “I” section of each connecting member slides within a vertical slit (159) down the center of each elastomeric strip, opening and then closing the slit as it travels vertically.

The fixed flap valve (122) at the top of the pump assembly is substantially the same as the movable flap valve, except that instead of being connected to an outer drive disk, it is fastened to the inner surface of the rigid tube and sealed with a marine sealant. A PVC cap (160), affixed to the center of the fixed valve disk, caps the top of the pump shaft (152) and secures the shaft in place. The support framework (126) at the bottom of the pump assembly comprises a hub (166) and a plurality of spokes (162), each of which is attached at its outer end to a bracket (164) that is mounted onto the rigid tube. The preferred material for the support framework is PVC, except for the stainless steel brackets.

PROPULSION. The preferred embodiment includes a propulsion and steering system that is comprised of a device for: (a) propelling the apparatus through the water, (b) controlling the direction in which the apparatus moves, (c) imparting directional stability to its motion through the water, (d) receiving directional instructions from an on-board source and/or from a remote location, and (e) translating the directional instructions into physical action.

The device for propelling the apparatus through the water in the preferred embodiment comprises three steering vane panel sets mounted on pipe couplers (130a, 130b and 130c), with the upper steering vane panel set (120a) mounted near the top of the rigid tube, the lower steering vane panel set (120b) mounted near the bottom of the rigid tube, as shown in FIG. 1a, and the third steering vane panel set mounted near the lower end of the tube extender, as shown in FIG. 1c. Each assembly comprises left- and right-mounted, otherwise identical, steering vane panel sets, with the steering vane panel assemblies mounted on opposite sides of each pipe coupler and at the same distance from the top of the tube. The steering vane panels of each assembly are vertically aligned with each other. Due to ocean-surface turbulence, the upper steering vane panel set should be constructed to withstand greater stress forces than required by the lower steering vane panel set.

FIG. 4a shows a back and front view of a single steering vane panel assembly in the preferred embodiment. Each set comprises an upper steering vane panel (188) and a lower steering vane panel (190), with each steering vane panel pivoting independently on a butt-type hinge (186). The steering vane panels share a common hinge shaft (187) that rotates within the hinge knuckles (204). The vertical stop (182) is fabricated from fiberglass. Each steering vane panel assembly is mounted onto the pipe coupler by means of a PVC flange (196) and a PVC flange backer plate (198) and fastened with stainless steel mounting hardware. The steering vane panels are on the front side of each steering vane panel assembly, where the front is determined by the direction of motion of the apparatus.

Details of the construction of a steering vane panel assembly in the preferred embodiment are shown in the side view in FIG. 4b. The hinge (186) is fabricated from stainless steel and is incorporated into the construction of the fiberglass steering vane panels (188 and 190); the outer surfaces of the hinge knuckles (204) are also covered in fiberglass (202). Stainless steel reinforcing pins (210) or projections through the hinge leaves (208) reinforce the bond between the hinge leaves and the fiberglass panels. The hinge knuckles are lined with a layer of PTFE (206) to minimize friction between the knuckles and the solid PVC hinge shaft (187). FIG. 4b also shows the detail of the outer or leading edge of the upper and lower steering vane panels. They are flared and beveled so that the upper panel (188) will rotate away from the vertical stop (182) by water acting on the bevel (242) when the apparatus is ascending from a wave trough, and it will be pushed against the vertical stop by water acting on the flare (240) when the apparatus is descending from a wave crest. Conversely, the lower panel, shown at the right of FIG. 4b, will rotate away from the vertical stop when the apparatus is descending from a wave crest and be pushed against the vertical stop when the apparatus is ascending from a wave trough.

Referring to FIG. 4c, a steering vane panel assembly is assembled as follows: position both the upper and lower steering vane panels (188 and 190) so that the hinge knuckles (204) are aligned. Insert the hinge shaft (187 in FIG. 4a) so that the slot in the hinge shaft is aligned with and exposed through the slot (176) in the center hinge knuckle. Insert the vertical stop (182) through the slot, exposing the two pinholes (178). Install the two stainless pins (180) into the pinholes. Finally, install stainless steel fairleads (214a and 214b in FIG. 4b) in the upper and lower portions of the vertical stop.

FIG. 4b shows the preferred embodiment assembly for controlling the rotation of the steering vane panels (188 and 190) about the hinge shaft (187) and away from the vertical stop (182). This assembly comprises a braided marine nylon line or rope (212), one end of which is spliced onto a ring (216) that is fabricated as part of a weighted container (218). The container is constructed of a rugged polymer, filled with sand and topped with seawater, and its total weight should be adjusted to reliably prevent any slack in the rope when the steering vane panels are rotating outward.

To prevent the weight from swinging and damaging the vertical stop, it operates within a travel-guide tube (220) constructed from PVC pipe that is affixed to the steering vane panel with PVC clamps (222). The other end of the rope passes through the smooth stainless steel fairleads (214a and 214b) mounted in either side of the vertical stop (182), and through a hole in the steering vane panel. The fairleads minimize abrasion of the marine rope. Finally, a first nylon stop (224a) is clamped to the upper end of the rope and a second nylon stop (224b) is clamped to the rope a short distance above the weighted container ring (216). The second nylon stop is disposed such that the rotation of the steering vane panel is limited to approximately 45° from the vertical stop when wide open. (To the extent that the prevailing orientation of the apparatus is not vertical—say, due to strong currents affecting only part of the apparatus—the optimal angle of the steering vane panels with respect to the vertical stop may deviate from 45°.) Each steering vane panel is fitted with a similar assembly for controlling panel rotation (see FIG. 4a).

STEERING. FIG. 4a shows a rope-clamp solenoid (226) mounted on the vertical stop in combination with the lower weight assembly. It enables the rigid tube (100) to change its direction of travel. FIG. 4e shows details of the rope-clamp solenoid and its non-corrosive, sealed housing and mounting strap (230). A D-ring (228) is attached to the exposed end of the pull-type solenoid plunger, and a ribbed clamping strip (232) holds the marine rope in place when the solenoid's plunger is energized. The rope-clamp solenoid is powered directly or indirectly by a solar cell. A battery (116) is the indirect energy source. The wedge-shaped, rigid plastic fairing (106) and the shape of the tube extender (132) impart directional stability to the apparatus.

The means for receiving directional instructions from an on-board source is the global positioning system (GPS) that is included with the apparatus's electronics package (112). The means for receiving directional instructions from a remote source or location is an antenna-equipped receiver, which is also included in the electronics package.

The means for translating the directional instructions into physical action is an electrical or printed circuit board (PCB) that includes a processor and memory with encoded instructions. In “local” mode, software compares the desired position of the apparatus with its actual position, as determined by the onboard GPS. The encoded instructions determine when the PCB is to signal the rope-clamp solenoid(s) (226) to engage and for how long. In the “remote” mode, the directional instructions are received by the PCB from a remote location and similarly are translated into signals sent to the rope-clamp solenoids.

The rope-clamp solenoid is normally energized when the apparatus is ascending; i.e., when the movable valve (124) is on its downstroke. This is facilitated by a mercury switch (246) in the preferred embodiment. This switch is attached to the external wall of the vacuum tank (252) of the water-ballast system (108 in FIG. 5c) by an elastomeric hinge (248) and a bracket (244). The contacts are on the hinged end of the mercury switch, so the contacts close when the unattached end of the mercury switch is elevated; i.e., when the movable valve (124) is moving away from the fixed valve (122). The signal from the PCB to the rope-clamp solenoid goes through the mercury switch, so the solenoid can be energized only when the mercury switch is closed.

SUBMERSION. In the preferred embodiment, the apparatus has the capability to submerge below the surface and to re-emerge when conditions are favorable. This system is mounted on the rigid tube (100) on its trailing side; i.e., orthogonal to the axis of the steering vane panel sets and at the rear of the apparatus when it is moving forward. The main components of the submersion system are shown in FIG. 5a and comprise a tank or chamber for holding pressurized air (250); a vacuum tank or chamber (252) that contains a (partial) vacuum when the apparatus is on the ocean surface; a tank or chamber for holding water ballast (254); a one-way air pump (262) for transferring air from the vacuum tank to the pressurized air tank; a first one-way solenoid air valve (264) for transferring air from the pressurized air tank to the vacuum tank; a two-way solenoid air valve (266) for allowing airflow between the vacuum tank and the ballast tank; a thru-hull fitting (270) to permit seawater to flow into and out of the ballast tank; an upper fairing (256) and a lower fairing (258) to facilitate the laminar flow of water around the apparatus when it is ascending and descending; a strainer (272) fitted into the apex of the lower fairing to screen out foreign objects; and a printed circuit board (PCB) with embedded coded instructions for signaling the transfer of water ballast into and out of the ballast tank by controlling the submersion system's electrical components. The PCB is contained within the electronics package (112 in FIG. 1a). Arrows shown on the electric components in FIG. 5a indicate the direction of airflow.

If air needs to be replenished to the system, a second one-way solenoid air valve (268) permits fresh air to enter the vacuum tank via an air tube (260) that extends to the surface. This air tube runs upward along the outside of the submersion system tanks, over to the rigid tube (100), and finally up the outside of the rigid tube to the flotation device on the surface, forming an inverted “U” as it curves around the top of the flotation device with its end facing downward. A ball-check valve at the end of this air tube inhibits water from entering the tube. In the preferred embodiment, the electronic components (262, 264 and 268) are housed inside a waterproof compartment between the pressurized air tank and the vacuum tank. An electronic depth gauge, included in the electronics package (112 in FIG. 1a), facilitates maintaining the apparatus at a predetermined depth when it is submerged. A PCB with embedded digital instructions controls the action of the depth control system, including ascending, descending and, with the aid of the electronic depth gauge, maintaining a given underwater depth.

In the preferred embodiment, when an oncoming vessel approaches the apparatus, the apparatus submerges. To implement this feature, all vessels plying waters populated by the apparatus would have a legal requirement to transmit a continuous directional signal that would be received by any functioning apparatus in the vessel's path. A transmitter range of a mile would likely be sufficient, except for unusually fast vessels. When the antenna and receiver aboard the apparatus receive the appropriate transmitted signal, the PCB is signaled to initiate the submersion process.

In the preferred embodiment, the apparatus also possesses a means for detecting heavy sea conditions. A simple bell-shaped motion detector (310), such as that shown in FIG. 5b, can provide adequate warning. This device is housed within the electronics package (112 in FIG. 1a). Sufficiently unsettled seas cause the stainless steel clapper (300) to contact the stainless steel bell casting (302), closing an electrical circuit (304) and signaling the PCB to initiate the submersion process. The height of the clapper is adjustable: by raising (lowering) it within the bell casting by means of an adjusting nut (306), it will become more (less) sensitive to turbulent motion. An insulator (308) keeps the clapper electrically isolated from the bell casting. To reduce the likelihood of false alarms, the clapper is required to make contact with the casting a predetermined number of times within a given time period before the onboard electronics signal the apparatus to submerge.

When the apparatus determines that conditions might be favorable to return to the surface, it begins its ascent. As it approaches the surface, if the clapper contacts the casting a predetermined number of times within a given time period, indicating turbulence, the apparatus re-submerges. The frequency with which attempts are made to resurface would depend upon the average duration of heavy sea conditions in the local area and the electrical charge status of the battery, as the system is reliant on battery power to resurface. In a preferred embodiment, the decision on when to submerge and re-emerge due to heavy seas would be based on satellite weather information, with appropriate instructions sent electronically to a receiver onboard the apparatus and included in the electronics package.

In a further embodiment, an emergency-ascent capsule (320 in FIG. 1a) is tethered to or mounted on the apparatus to provide a means for ascent if the primary ascent system should fail. This capsule contains a packed bladder that can be inflated by a self-contained CO2 cartridge when signaled by an onboard receiver. When the receiver receives an encrypted dedicated wireless signal, a solenoid punctures the CO2 cartridge, releasing gas into the bladder. As the bladder expands, it forces the ends of the capsule to be ejected and provides the apparatus with sufficient buoyancy to ascend to the surface. Ideally, the receiver is capable of receiving the remote signal even if the apparatus is resting on the ocean floor.

### Operation—FIGS. 1-5

The present invention deprives tropical waves of the heat energy they require to develop into tropical cyclones. The invention is a wave-driven apparatus that pumps cooler water from below the ocean surface and redistributes it onto or near the ocean surface. As already noted, to inhibit the formation of tropical cyclones, the surface waters must be kept below 80° F. The preferred embodiment is the apparatus shown in FIG. 1a. A rigid tube (100) and tube extender (132) extend down from the ocean surface to a region where the water is cooler than sea surface temperatures by at least several degrees during warmer months. The lower extent of a thermocline would serve best. A flotation device (102) attached to the top of the tube enables the apparatus to float on the ocean surface, while a weighting device (104a) at the bottom of the rigid tube (100) causes the apparatus to be suspended from the surface in a substantially vertical position. The weighted device (104b) at the bottom of the tube extender keeps the extender fully extended.

PUMPING. As the apparatus rides the waves, a pump within the rigid tube forces water out through openings (168) near the top of the tube, at the same time sucking water in through the bottom of the tube extender. The main components of this pump are a fixed flap valve (122), a movable flap valve (124) and a support framework (126) that anchors a shaft (152), along which the movable valve slides. The movable valve is attached to a flat outer drive disk (128) by rigid connecting members (118) that project through slots (156) fabricated into the rigid tube.

In deep water, the vertical motion of water due to surface action drops off rapidly with depth, so that both the flat outer drive disk and the movable valve to which it is attached largely maintain their vertical position relative to the ocean floor while the pump is operating. When the apparatus is riding waves on the ocean surface, the fixed valve oscillates with respect to the movable valve, pumping seawater upward through the tube and tube extender.

FIG. 3 shows the action of the fixed (122) and movable (124) flap valves as the rigid tube (100) is moved vertically by wave action. In this figure, the wave motion is from right to left, as indicated by the upper arrow; the direction of the apparatus relative to the waves is indicated by the lower arrows above the apparatus. The vertical arrows above and below the movable valve show the direction of motion of the movable valve relative to the fixed valve. The action of the flaps of both the fixed and movable valves is also shown.

As the apparatus comes off of a wave crest and begins its descent, ambient water pressure acting on the lower face of the flat outer drive disk (128) keeps the movable valve (124) substantially in place, while the tube (100) slides downward and water pressure above the movable valve keeps its flaps closed. As water inside the tube above the movable valve is pushed upward, the fixed valve (122) is forced open and water spills out onto the near-ocean surface through the openings (168) near the top of the tube. At the same time, reduced water pressure below the movable valve causes water to be sucked in through the bottom of the tube extender.

As the apparatus ascends toward the crest of the next wave, water pressure acting on the upper surface of the flat outer drive disk creates a pressure drop in the volume of water between the fixed and movable valves as the tube slides away from the movable valve. This pressure drop causes the flaps of the fixed flap valve to close and the flaps of the movable flap valve to open. Pressure is equalized as water flows up through the movable valve. When the apparatus reaches the wave crest, the cycle begins again.

PROPULSION. In the preferred embodiment, the apparatus has the ability to navigate through the water in a specified direction by means of a propulsion and steering system. Given the tendency of the apparatus to be moved by the action of wind, waves and currents, this system can—within limits—maintain the apparatus in a globally fixed position. The navigation system also enables the apparatus to travel to another specified location, and/or to maintain a given distance between itself and other like apparatuses so that a relatively uniform distribution of cooler water onto the sea surface can be achieved.

Referring to FIG. 4b, when the apparatus is moving upward through the water, water pressure on the bevel (242) of the upper steering vane panel (188) causes the panel to rotate outward until the second nylon stop (224b) on the marine rope (212) is stopped by the outer fairlead (214a). At the same time, water moving over the flared bottom edge (240) of the lower steering vane panel (190) will push and hold this panel against the vertical stop (182). Gravity acting on the weighted container (218) prevents any slack from forming in the lower panel's marine rope, which could otherwise interfere with the closing of the lower steering vane panel.

Given the upper steering vane panel's angle of attack as it ascends, water impinging on the panel's upper surface imparts a horizontal component to the motion of the steering vane panel, and therefore to the apparatus. The operation is similar when the apparatus is descending through the water, except that the lower steering vane panel is rotated outward, while the water flow presses the upper steering vane panel against the vertical stop.

Another substantially identical steering vane panel assembly is installed on the opposite side of the pipe coupler (130a in FIG. 1a) and oriented in the same direction as the first set. As the tube undulates in the waves, substantially equal water pressure acting on both upper steering vane panels causes the apparatus to make way through the water in approximately a straight line, its directional deviations dampened by the wedge-shaped fairing (106 in FIG. 1e) attached to the front of the rigid tube. As long as the upper steering vane panels' angle of attack through the water is the same, the apparatus will be propelled in the same substantially linear direction on both the upstroke and downstroke of the rigid tube. By positioning a steering vane panel set near the top of the rigid tube, another set near the bottom of the rigid tube, and a third set near the bottom of the tube extender, the efficiency of the movement of the apparatus through the water is significantly increased.

The direction of motion of the apparatus will be approximately at the same angle and in the same direction as the opened steering vane panels, but the length of the flare and the slope of the bevel can affect that direction. The horizontal progress of the apparatus through the water can be optimized by adjusting the length of the marine rope (212) between the two nylon stops (224a and 224b).

Steering the apparatus is accomplished by controlling the outward rotation of the lower steering vane panels mounted on the front of each steering vane panel set. A lower steering vane panel is prevented from rotating outward by energizing the rope-clamp solenoid (226 in FIG. 4a) mounted on the back of the vertical stop. When the apparatus needs to change direction, a printed circuit board (PCB) receives a signal either from the onboard GPS or from a remote location. This signal is converted into an electrical current that is sent to the appropriate solenoid. For turning the apparatus, one and only one solenoid in the steering vane panel set is energized, which holds its steering vane panel in the closed position, while the lower steering vane panel in the opposite assembly is permitted to open.

When the apparatus is to be turned in a clockwise direction, as viewed from above, the rope-clamp solenoid on the lower right steering vane panel is energized on all three steering vane panel sets (120a, 120b and 120c in FIG. 1a); and when the apparatus is to be turned counterclockwise, the rope-clamp solenoids on the lower left steering vane panels are energized. The length of time the solenoid is energized determines the amount of turn.

The PCB is populated with a processor and a memory encoded with program instructions. In one operational mode, the program instructions compare the apparatus's desired global position with its actual global position. If a change in position is called for, the processor determines which rope-clamp solenoids, if any, to engage and for how long in order to orient the apparatus in the desired direction. In another operational mode, the PCB receives its input from a remote location. Because the apparatus could be driven off course by wind, waves and currents to a point of no return, a decision could then be made at a remote location how best to deploy the apparatus for future operations. Instructions resulting from the decision would then be transmitted to the master apparatus's PCB via its antenna and receiver included in the electronics package (112). It would then transmit instructions to the apparatuses under its control, which units are also capable of receiving instructions remotely.

Referring to FIG. 4, in the preferred embodiment, a marine rope (212) goes through a rope-clamp pull-type solenoid (226 in FIG. 4e) mounted on the back of the vertical stop (182 in FIG. 4a). When the apparatus is at or near a wave crest and starts its descent, the mercury switch (246 in FIG. 5c) closes, and the solenoids are energized on the apparatus's downstroke.

Referring to FIG. 5c, the mercury switch is mounted on the external wall of the vacuum tank (252) of the water-ballast system (108 in FIG. 5a) by an elastomeric hinge (248) and a bracket (244). The electrical contacts are on the hinged end of the mercury switch, and these contacts close when the unattached end of the mercury switch is pushed upward by the flow of water, which happens while the apparatus is descending. During descent, the electrical current from the PCB can go through the mercury switch and energize the appropriate solenoid.

Referring again to FIG. 4e, when the solenoid is energized, the D-ring (228), through which the rope passes, pulls the rope against the ribbed clamping strip (232), thereby preventing the lower panel from rotating outward. Each of the lower panels is similarly configured.

SUBMERSION. In the preferred embodiment, the apparatus also has the capability to submerge when facing hazards such as oncoming ocean vessels and heavy seas, or when ocean waves are too small to pump water from the lower depth, or to avoid a strong, adverse surface current. Moreover, unless the apparatus needs to reposition itself or recharge its batteries, submersion also may be preferable when the water temperature at the base of the tube extender is not sufficiently cooler than the water at the surface. In this last case, a further embodiment would include an electronic temperature sensors mounted at the top of the rigid tube and at the bottom of the tube extender and integrated with the PCB.

The components of the submersion system are shown in FIG. 5, and the action of the electronic components is described in the table below. When the apparatus is on the ocean surface, the air pump (262) is turned off and both the first one-way solenoid air valve (264) and the two-way solenoid air valve (266) are in the normally closed position. Air is fully pressurized in the upper tank (250), a (partial) vacuum exists in the middle tank (252), and a relatively small amount of seawater is in the bottom of the water-ballast tank (254). When the submersion system is signaled to submerge, the two-way solenoid air valve (266) opens, causing air to rush from the ballast tank into the vacuum tank. This reduces air pressure in the ballast tank, causing water to rapidly enter through the thru-hull fitting (270), thereby causing the apparatus to submerge. When the electronic depth gauge signals that the apparatus is nearing its desired depth, the first solenoid air valve (264) opens, allowing pressurized air to flow through the vacuum tank and into the water-ballast tank, displacing enough water to achieve neutral buoyancy, at which point the two-way solenoid air valve (266) closes. The air in both the upper and middle tank is still under positive pressure, though pressure remains greater in the upper tank. The air pump then pumps air from the vacuum tank into the upper tank to achieve a proper pressure differential between the vacuum tank and the ballast tank.

| Component | Maintain | Submerge | Stabilize | Maintain | Ascend | Stabilize | Maintain |
|---|---|---|---|---|---|---|---|
| 262 | Off | Off | Off | Off | Off | On | Off |
| 264 | Closed | Closed | Open | Closed | Open | Closed | Closed |
| 266 | Closed | Open | Closed | Closed | Open | Closed | Closed |

While the apparatus is maintaining its depth below the surface, a PCB with embedded digital instructions receives signals from the electronic depth gauge, which it compares with the desired depth. If the desired depth is greater than the actual depth by some predetermined amount, the PCB signals the two-way solenoid air valve (266) to open and initiate the submersion process. If the desired depth is less than the actual depth by some predetermined amount, the PCB signals both solenoid air valves (264 and 266) to open and initiate the ascension process. Otherwise, the PCB maintains the current depth within an appropriate range.

Whenever the submersion system is signaled to ascend, both solenoid air valves are opened for a predetermined time, allowing air under pressure to enter the ballast tank and forcing water out through the thru-hull. After both valves are closed, the air pump (262) re-pressurizes the upper tank (250), creating a partial vacuum in the middle tank (252). This prepares the apparatus to submerge again.

If, during an ascent, the motion detector (310 in FIG. 5b), located in the electronics package, detects adverse environmental conditions, or it is signaled that a vessel is approaching, ascent is suspended, and the apparatus is signaled to descend to the desired level as described earlier. The PCB also has the capability to signal the apparatus to re-emerge on demand, after, say, receiving an external electronic signal from a maintenance crew.

To fully implement the submersion capabilities of the apparatus, all vessels plying waters populated by the apparatus would have a legal requirement to transmit from an onboard transmitter a directional signal along the vessel's path and to a depth of, say, 100 feet below the vessel's draft. The latter requirement will prevent an apparatus from ascending into the path of a vessel or into the vessel itself. In this embodiment, when the apparatus receives the transmitted signal, it interprets the signal as an instruction to submerge. If it is already ascending, it must open the two-way solenoid air valve (266), and, at the same time, pump air from the vacuum tank into the pressurized air tank, thereby sucking seawater into the ballast tank and causing the apparatus to submerge.

In the preferred embodiment, the apparatus also possesses the means for detecting heavy sea conditions, as well as the means for detecting the absence of such conditions so it can return to the surface. The simple, bell-shaped, turbulence detector (310), shown in FIG. 5b and mounted within the electronics package, can provide adequate warning. Sufficiently unsettled seas will cause the clapper (300) to make contact with the bell casting (302), closing an electrical circuit (304) and signaling the water-ballast system (108) to initiate the submersion process. An insulator (308) keeps the clapper electrically isolated from the bell casting. To reduce the likelihood of false alarms, the clapper is required to make contact with the casting a predetermined number of times within a given time period before the onboard electronics signal the apparatus to submerge.

To determine when it is safe to return to the surface, the same criterion is applied: as the apparatus is approaching the surface, if the clapper contacts the casting a predetermined number of times within a given time period, the apparatus re-submerges. The frequency with which attempts are made to resurface will depend upon the average duration of heavy-sea conditions, as well as on the charge status of the on-board battery. The latter criterion is imposed to minimize the chance that the battery will be drained beyond further use, thereby rendering the submersion system inoperative. However, in the preferred embodiment, the decision when to submerge and re-emerge is based on satellite weather information, with appropriate instructions sent electronically to the antenna and receiver onboard the apparatus.

### Use of the Invention

The task of reducing sea surface temperatures (SSTs) to below 80° F. requires that a large number of apparatuses be distributed over a region of the ocean, and particularly the ocean region off the West Coast of Africa, where most powerful Atlantic cyclones originate. In this region, SSTs in the summer normally do not exceed 86° F.

It has been determined that the current invention offers both a technically and financially feasible solution. The method will be technically feasible if it can be shown how surface temperatures can be reduced by 5° to 6° F.; it will be financially feasible if the expected direct and indirect costs attributable to future tropical cyclones are sufficiently greater than the cost of inhibiting the formation of tropical cyclones by producing, distributing, launching and maintaining a sufficiently large fleet or fleets of the current invention.

If the current invention is operating in an oceanic region in which the average wave height over a typical 24-hour period is four feet and the average wave period is seven seconds, then, if its rigid tube has an inside diameter of five feet and its pump operates at 80% efficiency, it will disgorge about 775,000 cubic feet of cooler water per day or nine cubic feet per second onto the near-ocean surface. The volume of water pumped over the course of a month by a single apparatus and spread uniformly over an area of one square mile would have a depth of 10.0 inches, or, in a year, 10 feet, less any output lost while in a submerged state.

The efficiency of the pump will be less than 100% because there will be some vertical movement in the drive disk (128) relative to the water in which it directly operates, and also because the ambient water itself will have some vertical motion due to motion on the ocean surface. I estimate that the efficiency loss from the latter will be about 12% if the drive disk is 15 feet below the wave trough and the wave length is 60 feet. In addition, the flap valve flaps may be momentarily open at the beginning of each stroke, though this pumping loss should be minor. Furthermore, there may be minor leakage through the movable valve's bushing (150), around the elastomeric annulus or seal (142) and around the flaps (146) of the flap valves. Finally, leakage will occur through the slits (159) in the elastomeric strips (155) that cover the vertical slots (156) in the rigid tube.

Under most conditions, the volume of pumped water will be sufficient to cool the ocean surface waters surrounding each pump. Because, over deep water, nearly all of the water circulation and mixing occurs in the region near the surface, the cooler water will mix well with the surface waters, and the dissipation of the cooling effect to waters several feet below is likely to be small. Moreover, the effect of wind and the Stoke's drift will further cause the cooler waters disgorged from the apparatus to spread outward.

If a large plurality or fleet of apparatuses is deployed in the area off the West Africa coast, but more specifically, in the area somewhat north of 16° North latitude and between 18° and 23° West longitude, then the cooler water from the apparatuses will be driven by the prevailing winds, waves and surface currents southward initially, and then westward, along the same pathway where most major tropical cyclones form, develop and make their journey to the Western Hemisphere. Of course, the cooler water may be slowly dissipated to deeper waters the further it travels, which suggests that booster fleets of apparatuses may need to be deployed along the westward pathway. On the other hand, the effect of just the original fleet of apparatuses off the West Africa coast may be sufficient to disrupt the sequence of environmental conditions needed to generate most tropical cyclones.

If surface currents are inadequate to move the cooled surface waters to the south and then to the west, then the ability of the apparatuses to reposition themselves can be used to deploy at least some of the apparatuses further to the south where the currents tend to be stronger. If the efficiency of the steering vane panel sets is 70 percent, average wave height four feet and the wave period seven seconds on average, then the apparatus will be able to make way through the water at a speed of over one-half mph, or nearly 25 cm/s.

A person skilled in the art will be able to determine the number and placement of apparatuses required to provide sufficient cooling in a given environment. As already noted, the output volume of the pump is readily determined from the diameter of the cylinder tube, the average wave period and wave height of the ambient waves, and the efficiency of the pump. Next, the volume of water that is to be cooled per unit time must be estimated. An upper layer of water is mixed as a result of wind and wave action, and water that is deeper than about half the wave length will experience little mixing. In addition, the horizontal velocity of water below the wave trough falls off rapidly with depth. The water volume per unit time that is to be cooled can be calculated as equal to the layer depth times the average velocity at which this upper water layer is moving times the average distance between pump centers.

The distance between pump centers, or, equivalently, the number of equally spaced pumps to be deployed, is determined in part by the temperature difference between the pumped cooler water and the surface waters: the greater the temperature difference, the greater this distance can be, and the fewer the number of pumps needed. In the earlier example, a five-foot-diameter rigid tube pumped nine cubic feet of cooler water per second. If the SST averages 88° F. and the water pumped up from a thermocline is 70° F., then to reduce the SST to no more than 79° F., the volumes of pumped water and warmer surface water per unit time must be in a ratio of at least 1:1. Thus, the average distance between pumps must be such that no more than nine cubic feet of warmer surface water per second crosses an imaginary line between adjacent pumps.

To minimize the number of pumps needed, the pumps should be placed where the sea surface waters are driven almost entirely by mild-to-moderate prevailing winds and any underwater currents move slowly. The navigational capabilities of the apparatuses enable them to proceed to locations characterized by these conditions. It is noted that in the ocean region of interest, currents at a depth of 50 feet (15 m) are less than two inches (5 cm) per second [http://www.cpc.ncep.noaa.gov/products/GODAS/]. Of course, normal wind and waves have virtually no effect on currents at a depth of 50 feet.

If 90,000 individual apparatuses were positioned equidistantly along a straight line between 18° and 23° West longitude in the region just north of 16° North latitude, their center points would lie just 17.6 feet apart. Assume wave height averages six feet, wave length 60 feet, wave period seven seconds, and that water mixing 15 feet below the wave trough is negligible. After adjusting for the difference in flow rates as a function of depth due to the Stokes drift, the average flow of ocean water between pumping units is estimated at 48 cubic feet per second. This compares well with the 54 cubic feet per second of cooler water that are pumped from each apparatus.

Having considered the technical feasibility of the project, we now consider the financial feasibility. A rough estimate of the current cost of each apparatus is $15,000 each. The cost of 90,000 units would then be $1.35 billion. Delivery and launch of the units should be no more than an additional 10 percent of these costs. Predrilled cylinder tubes and subassemblies (e.g., tube extenders, and steering and submerging subassemblies) could be stored efficiently on a delivery vessel, and final assembly of the units could take place on deck prior to launch.

As stated earlier, the apparatus is designed to operate at least five years without maintenance. However, there still will be failures and losses. Lost units, if not recovered, would have to be replaced, and it usually would be cost-effective to refurbish failed units. If the apparatuses are located within the approximately 300 miles between 18° and 23° West longitude, and within a relatively narrow band above 16° North latitude, two to four ocean-going vessels with tenders operating full-time could provide security, recovery, maintenance and replacement services.

When all costs are amortized, the annual cost of maintaining a fleet of 90,000 units is estimated at well under $300 million. Refurbishing a unit after five years of use should be considerably less than $5,000. The most expensive component, the rigid tube (100), estimated to cost about $160 per foot, should last indefinitely. Should booster fleets be necessary to provide additional cooling of SSTs along the tropical cyclone sea-lanes, costs would increase accordingly. However, even multiple fleets would not have to eliminate or mitigate many tropical cyclones to be cost-effective. As already noted, the total cost of losses from Hurricane Katrina alone was estimated at $108 billion (2005 U.S. dollars)

[http://www.nhc.noaa.gov/pdf/TCR-AL122005_Katrina.pdf, p. 13], and the estimated average annual cost of hurricanes in the U.S. is $9 billion in 2006 dollars, given the extensive urbanization along the coastal regions of the Atlantic Ocean. Moreover, nearly 85% of major hurricanes began as easterly waves off West Africa [Landsea 1993, cited at http://www.faqs.org/faqs/meteorology/storms-faq/part1/#b]. Thus, the full cost of maintaining a single fleet of the current invention would be about three percent of the expected costs incurred from Atlantic hurricanes.

### Other Embodiments

While the above description contains many specificities, these should not be construed as limitations on the scope of the current invention, but as exemplifications of the presently preferred embodiments thereof. Many other ramifications and variations are possible within the teaching of the invention. Examples are provided below. Thus the scope of the invention should be determined by the appended claims and their legal equivalents, rather than the examples given.

In most cases, the apparatus and its components can be constructed from a wide variety of materials. The best materials to use at any given time will depend on the environmental conditions in which the apparatus operates the durability and effectiveness of the materials and their cost. If dissimilar metals are used in combination, then zincs or other devices to protect against galvanic action should be installed.

In further embodiment of the apparatus shown in FIG. 1A:
the rigid tube has other than a cylindrical shape;
a radar reflector, a flag or pennant, and/or a strobe light mounted on a staff at the top of the rigid tube serves as a backup avoidance device in the event that oncoming vessels are unable to signal the apparatus to submerge to avoid physical contact;
a sound sensor included in the electronics package detects the sound of ship engines and initiates submersion procedures when such sounds are detected, thereby obviating the need for vessels to signal the apparatus.
a beaconing device that transmits bursts of information to a satellite system that can identify and report the GPS position of an apparatus and, optionally, its status (e.g., whether submerged or on the surface), and whether any components are malfunctioning. An alternative arrangement is to have this technology aboard only the master apparatuses, which would continually collect status and diagnostic information from the apparatuses under its control, transmitting any anomalous information via satellite. This embodiment could provide more time responses by maintenance vessels;
the printed circuit board contains an instruction set that allows diagnostics to be conducted on the electronics components, which can then be reported to the master apparatus, or, in the case of the master apparatus, directly to a maintenance unit. The instruction set would test the navigational electronics (e.g., GPS, rope-clamp solenoid, mercury switch), the submersion system electronics, (e.g., air pump, air solenoid valves, depth gauge, etc.), solar power system or generator/alternator, temperature sensors, tilt meter, etc. Some of the components could be tested for anomalous readings by comparing these readings with corresponding readings from nearby apparatuses; others would be tested to see if the apparatus responds, say by submerging or altering direction.

### Alternative Embodiments

The following are alternative embodiments to the current invention:
the elongated tube (100) has a diameter other than ten feet, depending, in part, upon the environmental conditions in which the apparatus operates;
the elongated tube has a non-cylindrical shape. In this embodiment, the perimeter of the fixed and movable valves are shaped to conform with the contour of the interior walls of the elongated rigid tube;
although the initial cost of each unit would be increased significantly, the tube extender is comprised of a sufficiently long, rigid, cylindrical tube and fairing. This would likely reduce maintenance costs, as the rigid tube could be cleaned and reused, whereas a tube extender made from plastic film would likely have to be replaced during each regular maintenance cycle. For improved directional stability, a skeg (170) can be added to the bottom of the rigid tube extender and installed with stainless steel brackets (172), as shown in FIG. 1f;
the flotation device (102) is a collapsible, inflatable bladder. An onboard small, electric air pump and solenoid air valve allow air to be added to or removed from the bladder to adjust the buoyancy of the apparatus. If this embodiment is used as a replacement for the water-ballast submersion system, a reversible air pump can be employed to remove air from the bladder more quickly and increase the submersion rate;
the flotation device (102) comprises a plurality of smaller flotation units;
the hinge (148) attaching each flap valve to the flap valve disk is replaced by an extended part of the flap valve, and the flap valve, or at least its hinge portion, is constructed from a durable elastomeric material having a low fatigue factor;
leakage through the vertical slots (156 in FIG. 2c) can be reduced further if the edges of the slit (159) in the elastomeric strips (155) form a closure-type seal, as in a Zip-lock bag with a slider. A two-way slider (158a) mounted atop the “T” section of the rigid connecting member (118) opens the slit ahead of it when the movable valve is moving toward the fixed valve, while a second two-way slider (158b) mounted on the bottom of the “T” section of the connecting member closes the slit behind it. When the movable valve is moving away from the fixed valve, the lower slider opens the slit ahead of it, while the upper slider closes the slit behind it. In this embodiment, the elastomeric strips are only unsealed near the location where the connecting member protrudes through the slit;
steering vane panel assemblies are mounted directly onto the rigid tube (100), omitting the pipe coupler (130);
an additional steering vane panel set is mounted on a pipe coupler that is between and adjoined to segments of the rigid tube (100);
an additional steering vane panel set is mounted on a pipe coupler that is between and adjoined to segments of the flexible tube extender (132);
the upper steering vane panel (188) and the lower steering vane panel (190) each operate on a separate horizontal hinge shafts (187); the hinge shafts are parallel to each other and vertically aligned;
the hinge shaft (187) is fabricated with a metal rod core for added strength;
a knot replaces each of the nylon stops (224a and 224b) clamped onto the rope, but serves the same function;
a rotary actuator key replaces the rope and rope-clamp embodiment. The rotary actuator (200) is mounted on the lower backside of the vertical stop, as shown in FIG. 4f. A pin (192) is inserted orthogonally through the outer end of the actuator's rotor shaft and projects through a keyhole (194) in the vertical stop and through the lower steering vane panel (190). When the actuator is energized, it rotates and pulls, locking the steering vane panel firmly against the vertical stop.
a spring-loaded rope winder mounted on the vertical stop (182) replaces each of the weighted containers (218) and weighted container rings (216);
instead of a separate solenoid rope-clamp (226), a solenoid clamping device is fabricated integrally with a spring-loaded rope winder, which replaces the weighted container assembly (216, 218, 220, 222 and 224b);
the rope-clamp solenoid or rotary actuator embodiment could be mounted on the upper steering vane panels instead of the lower steering vane panels, but this is a less-effective arrangement, as gravity acting on the lower panels assists in maintaining the panel in a closed position. This arrangement also would impede diving speed when the apparatus submerges.
instead of, or in addition to, solar panels as the primary source of electrical power, one or more generators (336), dynamos or alternators are installed within an elongated rigid tube that is the pump shaft (152 in FIG. 2). See FIG. 6. The generator is connected to the bushing (150) of the movable flap valve (124), and is driven by the drive disk (128). The generator assembly could be based on a 6-watt, 12-volt, bicycle light-type generator/dynamo (336) sealed within a non-corrosive housing. FIG. 6a presents a front view of the generator assembly, FIG. 6b a side view, FIG. 6c a top view, FIG. 6d—a detail of the right slide-shaft block (354), which is within bushing (150) for the movable valve, and FIG. 6e—a detail showing the pump shaft (152), bushing (150) and slide shaft (350). Referring to FIGS. 6a, 6b and 6c, the rotor shaft of the generator is rotated by a rack-and-pinion arrangement comprising a drive gear (338) and reduction gear set (340), and opposing vertical gear strips (344a and 344b), or racks, which are affixed to the gear-strip mount (342), or rack mount. The gear-strip mount is mounted onto the interior wall of the pump shaft and extends the full travel length of the movable valve (124 in FIG. 2a).

The reduction gear set is interposed between the drive gear and gear strips because the rotation of the drive gear, if driven directly by the gear strips, would likely be insufficient to achieve maximum electrical output from the generator. To stabilize the motion of the generator assembly in the horizontal plane, a guide rod (346), which is an extension of the generator rotor shaft, travels within a guide-rod channel (348). The guide rod channel is installed on the interior wall of the pump shaft nearly opposite from and parallel to the gear-strip mount (342). Components exposed to seawater are made from corrosive-resistant materials. For example, gears and gear strips in the preferred embodiment are made from nylon, while the slide shafts and guide rod are made from titanium or stainless steel.

The generator assembly is designed to generate electricity on both the upstroke and downstroke of the rigid tube (100). In the preferred embodiment, a mechanical means is used to slide the generator back and forth between the opposing gear strips. When the apparatus is ascending from a wave trough—i.e., when the movable valve (124 in FIG. 2a) is moving downward, away from the fixed valve (122 in FIG. 2)—water pushing from below on the lower bevel block (358) causes the generator to slide towards the first gear strip (344a), which it engages; conversely, when the apparatus is descending from a wave crest—i.e., when the movable valve is moving upward toward the fixed valve—water from above pushing on the upper bevel block (356) causes the generator to slide towards and engage the second gear strip (344b). The cap (160 in FIG. 2) is vented or replaced with a pipe coupling to allow water to flow through the pump shaft (152).

To slide between the two opposing gear strips, the entire generator assembly slides along two cylindrical, round-ended, titanium slide shafts (350) that slide within bores (352) that have been bored through the movable valve bushing (150) and into each polymer slide-shaft block (354) mounted on opposing sides of the generator housing. The slide shafts are oriented orthogonally to the rotor axis of the generator. The height of the bushing (150) is such that the bottom edge of the lower bevel block is at least ⅛″ above the lower end of the bushing, and the upper edge of the upper bevel block is at least ⅛″ below the upper end of the bushing.

To prevent the generator from pivoting around the slide shafts, a vertical, small-diameter domed pin (362) is pressed orthogonally through each slide shaft (350) near its inner end, as shown in FIG. 6d. In this figure, the bushing (150) side is distinguished from the slide-shaft-block (354) side. Opposing sides of the bushing are bored to receive the slide shafts, which are screwed into them; the outer bores are each covered with a cap (366 in FIG. 6e). The bores (352) for the slide shaft (350) are slotted (364 in FIG. 5d) to receive the pins, which prevent the generator from rotating about the slide shafts. Each slide shaft projects inward through a vertical slot (360 in FIG. 5e) fabricated into the pump shaft (152); these slots extend from the bottom of the cap (160 in FIG. 2a) on the pump shaft down to the top of the hub (166 in FIG. 2a) in the support framework (126 in FIG. 2a). The bushing (150), which contains the generator assembly, is attached to the movable valve disk (140 in FIG. 6e).
Instead of the pin (362) and slot (364) arrangement for the slide shafts (350) and blocks (354), an extra slide shaft is fitted to one or both slide shaft blocks (354) and the bushing (150). This will also prevent the generator assembly from pivoting.
The generator assembly is installed during the assembly of the apparatus as follows. Install the gear strips (344a and 344b) onto the gear-strip mount (342). Then install the gear-strip mount and guide-rod channel (348) onto the interior walls of the pump shaft (152), using pre-drilled, countersunk holes. Assemble the generator assembly inside the bushing by screwing the slide shafts (350) into the bores (352) from the outside of the bushing (150) until they are inside the slide-shaft blocks (354). Install the caps (360). Slide the bushing into the two slots (360) at the top of the pump shaft (152) and slide it down. Finally, attach the bushing to the movable valve disk (140).
The generator assembly uses only one gear strip, generating electricity on only the upstroke or downstroke of the rigid tube (100).
As a backup device, or instead of the bevel blocks, an electrical means, such as a solenoid, is used to shuttle the generator back and forth along the slide shafts. The solenoid replaces one of the slide-shaft blocks (354, 356) in FIG. 6, and its plunger is affixed to the inner end, or is an extension, of a shortened slide shaft (350). When the apparatus is ascending, the solenoid is energized, and the gears engage the first gear strip; and when the apparatus is descending, the solenoid is not energized, and the gears engage the opposing gear strip.
more than one generator can be used at the same time, in which case they are stacked and vertically aligned. Only the top and bottom generators have slide-shaft rods installed in order to provide a smooth and trouble-free operation. Toward this end, the generator assembly should have substantially neutral buoyancy to minimize frictional drag. This arrangement utilizes only one upper bevel block (356), which is mounted onto the top generator; and only one lower bevel block (358), which is mounted onto the bottom of the bottom generator. The generators charge the battery (116) installed in the weighting device (104) at the bottom of the rigid tube (100). It is desirable to pre-install the plurality of generators within a sealed waterproof container whereby only the geared components, the slide shafts and slide-shaft bores are exposed to seawater. The top and bottom surfaces of the container would be appropriately beveled and replace the upper and lower bevel blocks.
the smaller gear in the reduction gear set (340) and the gear strips are replaced by a drive wheel that is a friction roller and friction strips, respectively. For example, the former can be a ribbed stainless steel roller, and the latter can be ribbed elastomeric strips.
the water-ballast system comprises a two-chamber tank, similar to the preferred embodiment but without the vacuum chamber. A two-way air pump pumps air between the two chambers to control the volume of water in the lower chamber. This embodiment would be less expensive to produce, but the apparatus would not dive as quickly.

### Benefits from the Current Invention

From the foregoing description, several advantages of the invention are evident. It has been shown how the current invention, when implemented as a multi-unit fleet is capable of cooling SSTs to below 80° F. over a wide area. Relatively slow surface currents in the critical area off the West Coast of Equatorial Africa make this possible with a smaller number of deployed units.

The current invention requires no platforms to be constructed, no mooring lines to be secured and no external power other than from sun and waves. Its pump is powered by wave energy and has few moving parts, which will keep maintenance low and reduce risk of premature failure. Its electrical components are solar-powered with supplementary battery capability. Its onboard navigational ability provides the mobility to maintain a given position, to operate as an optimally spaced fleet or to be deployed to a more advantageous location. The apparatus can make way through the water at about 0.5 knots, depending on wave height and wave period, and therefore it can maintain its position against modest, adverse surface currents. It also can be instructed to proceed to a different location; for example, it can travel westward in the South Equatorial Current, further cooling the surface as it proceeds. Working its way southward to about longitude 50° West, it then can catch the Equatorial Countercurrent eastward (except in the winter months, when the Countercurrent is weak or nonexistent; but it could still make progress eastward using wave energy). The Countercurrent will carry the apparatus back to the Gulf of Guinea, where the travel cycle can begin anew.

The ability of the apparatus to submerge increases its survivability by avoiding collisions with ocean vessels and by preventing damage from major storms. Submersion also enables the apparatus to retard degradation when seas are too calm to produce sufficient wave energy and to remain on location when surface currents are too strong for holding an advantageous position.

The objective was to design a unit that is simple, rugged, versatile, and efficient. Because of the hostile environment in which the apparatuses would be operating, rugged materials are used throughout toward achieving a goal of five-year, maintenance-free operation. Simplicity of design for each of the apparatus's three main functions—pumping, navigating and submerging—contributes to this goal.

If the units are to be commercialized, they must be cost-effective. In the Background of this document, we observed that after adjusting hurricane loss estimates in the United States for changes in personal wealth and coastal county populations, the estimated average property loss from tropical cyclones amounts to $9 billion annually, and this estimate is based on only the 30 most costly hurricanes. Our estimate of the annual amortized cost of producing, distributing, launching and maintaining a fleet of the current invention off the West Coast of Africa would be under $300 million annually. It is quite possible that this fleet alone could disrupt the process of hurricane development. But even if additional fleets are required, the net benefits from of this invention with respect to property losses averted are still quite favorable, and this conclusion holds, even without consideration of the other less costly hurricanes as well as the lives saved.

What is claimed:

1. An apparatus for transporting cooler seawater from below the ocean surface to the near ocean surface, comprising:
a. a containing device, comprising an elongated rigid tube, open at both ends, for containing said cooler seawater during its transport;
b. at least one flotation device at or near the top end of said rigid tube such that said apparatus floats on said ocean surface;
c. at least one weighting device at or near the bottom end of said rigid tube such that said apparatus floats in a substantially vertical position;
d. a pumping device within said rigid tube powered by wave energy for forcing said cooler seawater upwards through the bottom of said rigid tube and out onto said near ocean surface;

2. The apparatus according to claim 1, wherein a flexible tube extender extends said containing device to a greater ocean depth, said tube extender, comprising
a. a length of flexible tubing that may include at its top end a tubular segment of shock-absorbing material;
b. the top end of said flexible tubing attached to and disposed around the bottom of said rigid tube in a sealing manner;
c. a weighting device attached onto or near the bottom end of said flexible tubing such that said flexible tubing is fully extended when suspended from said rigid tube;
d. a plurality of horizontally disposed ribs attached to the interior of said flexible tubing and spaced apart such that when said tube extender is fully extended, the interior of said flexible tubing is in an expanded state,
whereby said rigid tube and said attached flexible tube extender provide a continuous channel for cooler seawater entering the bottom of said flexible tube extender to the proximate top of said rigid tube, with substantially no intermediate seawater leakage.

3. The apparatus according to claim 1, wherein said pumping device comprises
a. a fixed one-way valve through which all said sea water transported through said rigid tube passes;
b. a movable one-way valve through which all said sea water transported through said rigid tube passes;
c. an outer drive disk connected to said movable one-way valve, whereby said outer drive disk substantially maintains its vertical position relative to ambient seawater, while wave-driven vertical motion of said rigid tube causes said movable valve to oscillate vertically within said rigid tube, thereby causing seawater above said movable valve to be pumped upward through said rigid tube, through said fixed valve and onto said near ocean surface.

4. The apparatus according to claim 3, wherein
a. said fixed one-way valve comprises a first horizontal disk with a centered cap attached to the upper end of a vertical shaft, and whose perimeter is attached in a sealed manner to the interior surface of said rigid tube; and a plurality of flap valves fabricated into the horizontal plane of said disk through which the one-way flow of seawater is upward;
b. a hub-and-spoke device is disposed below said fixed valve, comprising: a plurality of spokes attached to and projecting outward from a hub, said hub mounted onto the lower end of said vertical shaft; and a bracket attaching the outer end of each said spoke to said interior surface of said rigid tube;
c. said movable one-way valve is a second horizontal disk disposed between said fixed valve and said hub-and-spoke device, comprising: a bushing centered in said second horizontal disk through which said vertical shaft is slidable; a plurality of flap valves fabricated into the horizontal plane of said second disk through which the one-way flow of seawater is upward; an elastomeric, low-friction annulus attached to the outer perimeter of said second disk, said annulus forming a slidable seal with said interior surface of said rigid tube.
d. said outer drive disk is a third horizontal disk that encircles the exterior of said rigid tube and is connected to said second horizontal disk by means of a plurality of rigid members projecting through vertical slots fabricated into said rigid tube, whereby said vertical shaft slides in a reciprocating manner through said bushing in said movable disk, forcing seawater upward through said flap valves.

5. The apparatus according to claim 1, wherein said flotation device is a pneumatic tube surrounding and attached to the perimeter of said rigid tube at or near its upper end.

6. The apparatus according to claim 1, wherein said weighting device is a tube surrounding and attached to the outer perimeter of said rigid tube at or near its lower end, said tube containing material with a specific gravity exceeding that of seawater, whereby said apparatus floats in a substantially vertical position on said ocean surface.

7. The apparatus according to claim 1, wherein said apparatus includes at least one device for navigating said apparatus away from its current location.

8. The apparatus according to claim 7, wherein said navigating device comprises:
a. a mounting platform selected from the group: said rigid tube, a pipe coupler attached at an end of said rigid tube, and a pipe coupler that mechanically couples two separate segments of said rigid tube;
b. a set of two similar steering vane panel assemblies, each said assembly mounted at substantially the same distance from the top of said rigid tube and on opposite sides of said mounting platform;
c. each said steering vane panel assembly comprising an upper and lower rotatable steering vane panel and each fabricated from a substantially flat, rectangular sheet of rigid material;
d. each said steering vane panel connected to and rotatable about a horizontal shaft attached to a fixed flat vertical stop, including a single horizontal shaft that may be common to both said steering vane panels; the upper said panel opening from above and rotating away from said vertical stop; and the lower said panel opening from below and rotating away from said vertical stop;
e. a rotation-limiting device that limits the outward rotation of said steering vane panel away from said vertical stop;
f. multiple sets of said navigational devices being vertically aligned;
g. at least one electronic device to control the rotation of said steering vane panels;
h. to each said electronic device, a means for generating encoded instructions on when and for how long to prevent the outward rotation of said steering vane panel; and
i. an electrical energy source to power each said electronic device.

9. The apparatus according to claim 8, wherein the outer edge of each said steering vane panel has a bevel and a flare such that when water flows over said panel away from its rotational axis, water impinging on said flare rotates said panel inward against said vertical stop; and when water flows over said panel toward its rotational axis, water impinging upon said bevel rotates said panel outward until limited by a rotation-limiting device, whereby water pushing continually against an outward rotated panel causes said apparatus to move substantially in the direction of the leading edge of said panel.

10. The apparatus according to claim 9, wherein said rotation-limiting device comprises a rope-clamp solenoid assembly comprising:
a. a measured length of rope with a first stop attached at one end;
b. the unclamped end of said rope passing serially through: said steering vane panel; a first fairlead mounted on said vertical stop; said vertical stop; a second fairlead mounted on said vertical stop opposite said first fairlead; on at least one steering-vane panel in each steering-vane panel assembly, a rope-clamping device; a second stop; and a weighted container attached to the end of said rope;
c. said second stop clamped on said rope and disposed such that when said steering vane panel is rotated outward to its maximum desired angle, further rotation is restrained by said first and second stops;
d. said rope-clamping device, comprises:
i. a solenoid, with a pulling-plunger;
ii. the linear segment of a D-ring affixed to the exposed end of said plunger; said solenoid oriented and mounted on the surface of said vertical stop such that the opening of said D-ring is aligned with the opening of said second fairlead; and said D-ring is parallel with said vertical stop;
iii. a ribbed clamping strip, attached to said solenoid housing, traversing the inside of said D-ring and is disposed with its ribbed face facing the inner curved segment of said D-ring, whereby when said solenoid is energized, said rope is pressed between said inner curved segment of said D-ring and said ribbed clamping strip, thereby holding said rope in place and preventing outward rotation of said steering vane panel, causing said rigid tube to rotate, enabling said apparatus to proceed in a different direction; and
iv. said weighted container, slidable within a travel-guide tube and preventing slack in said rope while said steering vane panel is rotating toward said vertical stop;
e. a directional switch to restrict energizing of said rope-clamp solenoid to the period after an upstroke of said rigid cylinder has been completed and before its downstroke has begun; and
f. electronic devices for controlling said rope-clamping device comprising a printed circuit board containing a processor and a memory with encoded instructions; and
g. an electronic devices selected from the group: global positioning system, whereby the actual global position of said apparatus is compared with the desired global position, and said printed circuit board signals said rope-clamping device to engage as necessary to reorient said apparatus toward said desired global position; antenna and receiver for receiving electronic signals from a remote location, whereby said desired global position is received remotely, signaled to said printed circuit board, which signals said rope-clamping device to engage as necessary to reorient said apparatus toward said desired global position.

11. The apparatus according to claim 1, wherein a depth-control device enables said apparatus to submerge below the ocean surface and to reemerge.

12. The apparatus according to claim 11, wherein said depth-control device comprises:
a. a first tank for holding pressurized air;
b. a second tank containing a partial vacuum when said apparatus is floating on the ocean surface;
c. a third tank for holding water ballast;
d. a one-way air pump for pumping air from said second tank to said first tank;
e. a first one-way solenoid air valve for controlling airflow from said first tank to said second tank;
f. a two-way solenoid air valve for controlling airflow between said second tank and said third tank;
g. a second one-way solenoid air valve for controlling airflow via an air tube leading from the atmosphere above the ocean surface to said second tank, whereby air can be replenished to the depth-control system as needed;
h. a thru-hull fitting at the bottom of said third tank, whereby seawater can flow freely into and out of said third tank;
i. an electronic device for measuring depth below the ocean surface;
j. a directional switch to ensure that said depth-control system is returned to a ready-to-submerge state after an ascent has occurred; and
k. an antenna for receiving signals from a remote location, said antenna signaling a printed circuit board that can selectively activate said air pump and said solenoid air valves,
whereby when said first tank is pressurized with air, when said second tank is under partial vacuum, when said third tank is mostly emptied of water, when said air pump is off and said first one-way and said two-way solenoid air valves are closed, then said apparatus is stable on the ocean surface in its ready-to-submerge state; when said two-way solenoid air valve is opened, water enters said third tank via said thru-hull fitting causing said apparatus to submerge; when said depth-measuring device reports that desired depth is attained, said first solenoid air valve opens until said apparatus achieves neutral buoyancy, at which time said two-way solenoid air valve closes; when said first solenoid air valve opens and said two-way solenoid air valve opens, water is expelled from said third tank through said thru-hull and said apparatus ascends; after positive buoyancy is achieved, said first solenoid air valve closes, said two-way solenoid air valve closes, and said air pump pressurizes said first tank while creating a partial vacuum in said second tank, thereby returning to the ocean surface in a ready-to-submerge state; and after said apparatus has completed an ascent, as detected by said directional switch, said air pump pressurizes said first tank to create a partial vacuum in said second tank, thereby restoring said depth-control system to a ready-to-submerge state.

13. The apparatus according to claim 12, wherein components of said depth-control system are combined into a single compartmentalized tank, comprising:
a. an upper, cone-shaped fairing to facilitate the laminar flow of water around said apparatus when said apparatus is ascending;
b. said pressurized first tank fitted and attached to the base of said upper fairing;
c. a sealed, moisture-free compartment fitted and attached to the base of said first air tank and containing:
i. said one-way air pump connecting said first tank and said second tank, and with one-way flow from said second tank into said first tank;
ii. said first one-way solenoid air valve connecting said first tank and said second tank, and with one-way flow into said second tank;
iii. said two-way solenoid air valve connecting said second tank and said third tank; and
iv. said one-way solenoid air valve connecting said second tank and atmosphere above ocean surface via said air tube;
d. said second tank fitted and attached to the base of said water-free compartment;
e. said third tank fitted and attached to the base of said second tank, with said two-way solenoid air valve connecting said second tank with said third tank; and said thru-hull fitting installed in the base of said third tank to enable the free flow of water into and out of said third tank;
f. a lower, cone-shaped fairing fitted and attached to the base of said ballast tank and facilitating the laminar flow of water around said apparatus when said apparatus is descending; and
g. a strainer installed in the apex of said lower fairing to filter out foreign objects that could create a blockage.

14. A method for inhibiting the formation of tropical cyclones, comprising:
a. pumping cooler seawater from a lower ocean depth to the near ocean surface through an elongated tube that floats vertically on the ocean surface, by utilizing wave energy;
b. navigating said elongated tube by means of a propulsion system powered by said wave energy in combination with a steering system;
c. submerging and re-emerging said elongated tube utilizing a water-ballast system;
d. providing electronic components for controlling said navigating, submerging and re-emerging functions comprising: a printed circuit board with a processor and a memory with encoded instructions; and including at least one electrical device selected from the group: global positioning system; turbulence detector; depth gauge; upper temperature sensor; lower temperature sensor; tilt meter; transmitter for signaling other apparatuses and remote receiving stations; and antenna and receiver for receiving from a remote location information and instructions by means of encoded signals; and
e. providing a power-generating source, comprising: selected from the group solar cell, generator and alternator; a storage battery; and a means for controlling electrical flow from said power-generating source to said storage battery.

15. The method of claim 14 wherein said pumping seawater comprises:
a. providing a rigid portion of said elongated tube;
b. providing a first horizontal valve attached in a sealing manner to the upper interior wall of said rigid portion;
c. providing a second horizontal valve, vertically movable in a sealable manner within said rigid portion below said first horizontal valve; and
d. providing a drive disk encircling said rigid portion and connected to said second horizontal valve by rigid members projecting through vertical slots fabricated into the wall of said rigid portion; and said second horizontal valve and said drive disk disposed at a sea depth at which the ambient seawater is substantially vertically stable,
whereby the distance between said fixed valve and said movable valve changes synchronously with ocean wave motion, thereby pumping cooler seawater up through said elongated tube onto said near ocean surface.

17. The method of claim 14, wherein said propulsion system comprises:
a. providing steering vane sets, each set comprising a substantially identical pair of steering vane assemblies, each said assembly disposed on opposite sides of and at the same distance from the top of said rigid portion;
b. providing each said assembly, comprising a flat, rigid vertical member attached to a horizontal shaft mounted orthogonally onto said rigid tube, and two substantially similar upper and lower steering vane panels, mounted vertically opposed onto said horizontal shaft, each said panel rotatable outward on said shaft away from said vertical member to a maximum angle of about 45 degrees; and
c. providing a rotation-limiting device for suppressing the outward rotation of at least one lower steering vane panel in each said steering vane set,
whereby when said elongated tube is ascending through ocean water, said lower vane panels are urged against said vertical member, while said upper vane panels are rotated away from said vertical member, thereby urging said elongated tube to move upward and laterally in the direction of the leading edge of said upper vane panels; when said elongated tube is descending through ocean water, said upper vane panels are urged against said vertical member, while said lower vane panels are rotated away from said vertical member, thereby urging said elongated tube to move downward and laterally in the direction of the leading edge of said lower vane panels, both said lateral movements being in substantially the same horizontal direction; and when said rotation-limiting device is activated, said elongated tube is reoriented toward a different compass direction.

18. The method according to claim 14 providing a water-ballast system comprising: a pressurized air chamber; a vacuum chamber; a water-ballast chamber with a thru-hull fitting; and electrical devices, comprising a depth-measuring device, an air pump capable of pumping air from said vacuum chamber to said pressurized air chamber, a one-way solenoid air valve connecting said air-pressurized chamber with said vacuum chamber, and a two-way solenoid air valve connecting said vacuum chamber and said water-ballast chamber, and a directional switch, whereby when said air chamber is pressurized, said vacuum chamber is under partial vacuum, said water-ballast chamber is mostly emptied of water, said air pump is off and said one-way and said two-way solenoid air valves are closed, said apparatus floats in its ready-to-submerge state on the ocean surface; when said two-way solenoid air valve opens, water enters said water-ballast chamber via said thru-hull fitting, causing said rigid tube to submerge; when said depth-measuring device signals desired depth attained, said first solenoid air valve opens and remains open until neutral buoyancy is achieved, at which time said two-way solenoid air valve closes; when said one-way and two-way solenoid air valves open, water is expelled from said ballast chamber through said thru-hull fitting and said rigid tube ascends; after positive buoyancy is achieved, said one-way and two-way solenoid air valves close and said air pump pressurizes said air-pressurized chamber while creating a partial vacuum in said vacuum chamber, thereby returning said rigid tube to the ocean surface in a ready-to-submerge state; and whenever said directional switch detects that said rigid tube has ascended, procedures are initiated to return said depth control system to a ready-to-submerge state.

19. A method for generating electricity from wave motion, comprising:
a. generating electricity from the group generator, dynamo and alternator, said electricity-generating device disposed transversely within an elongated rigid tube, having a spindle extending from one end of its rotor shaft and a drive gear mounted on the opposing end of said rotor shaft;
b. providing a reduction gear set comprising a smaller gear centered and attached side-by-side to a larger gear; said gear set mounted on an axle mounted to a bracket affixed to the drive-gear end of said electricity-generating device; said drive gear meshing with said larger gear in said reduction gear set;
c. providing a rack mount and a guide channel mounted longitudinally on opposing interior walls of said elongated rigid tube;
d. providing a channel grooved longitudinally into said rack mount, with a first rack mounted onto one side of said rack mount channel and a second rack mounted parallel to said first rack on the opposing side of said channel; with the distance between said parallel racks exceeding the maximum diameter of said smaller gear in said reduction gear set by some small distance, delta; and the width of said guide channel exceeding the diameter of said spindle by said distance delta;
e. providing a pair of slide shaft blocks mounted on opposing sides of said generator housing orthogonal to said rotor shaft; and each slide shaft block containing a centered, outward-facing bore;
f. providing the outer ends of each said slide shaft attached to a powered device that travels longitudinally along the outside of said elongated rigid tube; said slide shafts project through vertical slots fabricated into said elongated rigid tube; said slots are parallel to and have substantially the same length as said racks; and the unattached ends of said slide shafts project into and are slidable within said bores of said slide shaft blocks;
g. providing a means for sliding said generator and said slide shafts such that, when said powered device is moving vertically in one direction, said small gear of said reduction gear set is rotated by said first rack; and when said powered device is moving vertically in the opposite direction, said small gear of said reduction gear set is rotated in the same direction by said second rack; and said spindle is guided by corresponding side of said guide channel, whereby the generator is rotated in the same direction irrespective of the direction of motion of the powered device along said rigid tube.

20. The method according to claim 19, wherein said means for sliding said generator and said slide shafts is selected from the group mechanical means and electrical means.
